(19) United States
(12) Patent Application Publication
(10) Pub. No.: US 2003/0004838 A1
(43) Pub. Date: Jan. 2, 2003

(54) Information search system, information search method, call center system, server and information search apparatus

(75) Inventors: Rika Kusuda, Yamato-shi (JP); Katsuyoshi Matsumoto, Yokohama-shi (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY

(21) Appl. No.: 10/180,353

(22) Filed: Jun. 26, 2002

(30) Foreign Application Priority Data
Jun. 29, 2001 (JP) 2001-200188

(51) Int. Cl. G06F 17/60

(52) U.S. Cl. 705/27

(57) ABSTRACT

A system in which re-presentation of a search inquiry from an user to a call center can be omitted when a request for agent help is made. It is realized in an information search system that includes a user terminal 3 connected to a network such as the Internet 2, a call center Web server 7 for receiving a search condition sent from the user terminal 3 via the network, and an agent terminal 6 connected to the call center Web server 7. The call center Web server 7 search includes a search history preserving unit for preserving search histories, and an output unit for outputting a search history preserved in the search history preserving means to the agent terminal 6 when a connection request from the user terminal 3 to the agent terminal 6 is made.

### FIELD OF THE INVENTION

The present invention relates to an information search system and specifically to an information search system advantageously used in a call center that receives by telephone inquiries from users about products and the like.

### BACKGROUND OF THE INVENTION

Conventionally, in a call center where users inquire about products, specialized staff (referred to herein as ‘agents’) are in service to reply to inquiries from the users by telephone.

One of the known techniques for assigning agents appropriately could be Published Unexamined Patent Application No. 11-346266, for example.

On the other hand, businesses providing products have also provided Web sites about their products and replied to their users' inquiries on such Web sites, in addition to the use of agents. Many of the services provided at such Web sites allow a user to perform a search by entering keywords to describe an inquiry. Service at a Web site has the advantage that it has no temporal constraint, or requires little waiting time as compared to service by an agent by telephone.

### PROBLEMS TO BE SOLVED BY THE INVENTION

Services at Web sites for the users have the above advantage and are finding growing use. However, there can be a case where a user makes a search but gets no result or an inappriopriate result. In such a case, the user will typically call a call center and explain the content of his/her inquiry to an agent. This means that for the user the explanation to the agent will be the second presentation of the inquiry, as he/she once presented it to the company in the search made on the Web site. Thus the user gets an impression of burdensome requirements. Overall, for the call center and its agents as well, this is inconsistent with the basic policy of responding to user's inquiries quickly and appropriately.

Therefore, it is the object of the invention to provide an approach that a user need not re-present his/her inquiry to the call center.

### SUMMARY OF THE INVENTION

If the content of a search a user makes on a Web site is provided to an agent, the agent is able to grasp the content of the user's inquiry without requiring the user to tell the agent again what he/she wants to inquire about, or with less information even if he/she should tell it. In other words, the inventor has found that the object of the invention can be attained if a search condition, typically a keyword, entered by a user is informed to the agent that responds to the user.

The present invention is based on the above finding, and is realized in a system that comprises a user terminal connected to a network, a server for receiving a search condition sent via the network from the user terminal, and an agent terminal connected to the server. The server comprises search history preserving means for preserving the history of searches, and output means for outputting the search history preserved in the search history preserving means to the agent terminal when a request for connection from the user terminal to the agent terminal is made.

In the information search system according to the invention, the server preserves the search history and outputs it to the agent terminal in question when a request for connection from a user to the agent terminal has been made. Accordingly, the agent can grasp beforehand the content of a search made by the user in responding to the user. Thus the user can be saved from explaining his/her inquiry to the agent.

In the information search system according to the invention, one of the typical search conditions may be a keyword. An agent can grasp the request of a user by learning his/her keyword. Thus the agent can respond to the user promptly. However, the search conditions are not limited to keywords. There exist various modes of search, and a keyword search is merely an example of them. Therefore, it is intended that when another mode of search is adopted, any search condition conforming to the mode will be included. For example, in a case where selection is made from a l;ist of pulled-down items, the selecting action would correspond to the search condition.

In the information search system according to the invention, the history of searches includes search conditions and possibly other information. For example, in the case where information resulting from a search is provided in reply to a user and the user refers to the content of the information, if an agent learns the information to which the user referred, that information can be used by the agent in responding to the user.

The present invention also provides an information search method that is characterized by making a search based on a search condition entered by a user via a network, outputting the search result to the user, receiving a request for a response by an agent from the user that is made based on the output search result, and outputting the user's search history to the agent that responds to the request.

The information search method according to the invention applies when a user has obtained a search result that does not contain the information desired by the user. This is not necessarily a case where there is no hit with the search. There could be hit items that don't meet the user's need. The invention also covers such a case. If there is no hit item with a search, or if a user is not satisfied with the search results even if there are hits, the user will request a response from an agent. According to the invention, when such a request occurs, since the search condition has been output to the agent that responds to the request, the user does not have to explain the content of his/her request to the agent and the agent is able to respond to the user smoothly.

In the present invention, the request for a response by an agent may include a request for a response by telephone to the user and/or a response by e-mail to the user. When a request for a response by telephone is made, the agent will call the user, in which case the agent can grasp the search condition entered by the user in advance. When a request for a response by e-mail is made, the agent can grasp the search condition entered by the user to create an answering document by e-mail. The user can omit the task of entering his/her search condition again when requesting a response by e-mail. In addition, it is possible to have the user describe his/her inquiry when the user wants a response by e-mail. However, some users are not used to creating documents, and it is expected that inquiries made by such users could be incoherent. Compared to this, search conditions can be considered to be more objective information, which thus might reduce the agent's burden.

The above described information search system and the information search method are applicable to a call center system. Accordingly, the invention provides a call center system characterized in comprising information search means for performing a search based on a search condition entered by a user via a network, preserving means for preserving the search condition, receiving means for receiving a request for a response to the search by telephone or e-mail, selecting means for selecting an agent to respond, and output means for outputting the search condition and the search result that is based on the condition to the agent terminal used by the agent.

The call center system according to the invention outputs a search result and a search condition to an agent terminal. Therefore the agent can understand what the user wants to know through the search by referring to the search result and the search condition before responding to the user by telephone or by e-mail. There is also an advantage for the user that he/she doesn't have to explain his/her search condition again to the agent.

In the call center system according to the invention, the output of both search result and search condition to an agent terminal means that the agent might be able to point out the user's miss of relevant information. In other words, it is supposed that the user might miss an appropriate result that is included in the search result. The agent can point out the miss by referring to both the search result and the search condition.

The call center system according to the invention comprises a first data base that is open to the user and used for a search, and a second data base that is not open to the user, at least not directly, and used to perform a search for a search condition when a request for a response from an agent is made such as above described. An answering document for an inquiry about new products may not be presented to the user immediately after it is created, because it need to be corrected or checked for possible use of other company's trademarks. Meanwhile, the frequency of users' inquiries about new products is not low. Due to temporal constraints, however, information about new products may not be contained in the database open to the users. Hence, there can be no hit for the user's search in such a situation. Even in such a situation, hits for the user's search might exist in the database that is not directly open to the user, i.e., the database for in-company use. In the invention, therefore, the second database that is not open to users can be used to perform a search on accepting a request for a response by telephone or e-mail. The result of the search performed using the second database is output to the agent terminal. And if information for reply that meets the user's request can be extracted, the agent is able to reply smoothly by telephone or e-mail.

In the call center system according to the invention, the above described output means most desirably outputs the result of a search as a group of information. Thjat is, the result performed using the first database, the result of a search performed using the second database and the search condition itself is displayed to the agent as a group, so that the agent can reply to the user more rapidly and appropriately. Here, the term ‘to be output as a group’ means that the agent does not obtain these pieces of information separately, but can obtain them in a lump. For example, the invention includes a form that the information is displayed in a single screen on the display of a terminal, or it can be referred to in succession by scrolling the screen.

In the call center system according to the invention, it is expected that an inquiry made by a user is likely to be made repeatedly by other users. Therefore, the call center desirably comprises reply storing means for associating a search condition with a result and storing them when there is no hit in either the first database or the second database. By caching in this manner it is possible to avoid future fruitless searches.

According to the invention, a method of handling user requests in a call center as described below will be realized. Specifically, the invention provides a user request handling method characterized in that it recognizes a search condition from a user via a network, receives a request from a user for a reply from an agent, selects an agent terminal according to the request, and forwards the search condition to the agent terminal.

The invention provides the following novel server for providing search and call center services. The server receives a request for a search from a user via a network, outputs the result of a performed search to the user, and is characterized by search history preserving means for preserving the history of searches performed by the user, associating the search with identity information that identifies the search from other ones, and output means for outputting the search history preserved in the search history preserving means to an agent terminal used by an agent that will respond to a predetermined process request on receiving the predetermined process request for the search result from the user.

The server preserves the history of searches performed by a user by associating it with identity information, and outputs the history to an agent terminal responding to a predetermined process on accepting a predetermined request to be processed from a user. Thereby when the agent receives the search history, he/she can promptly identify the user and provide the user with an appropriate reply. The user need not trouble himself/herself to enter the search condition again for the agent.

In the server according to the invention, the output means is capable of outputting a search result to the agent terminal. This is done to enable the agent to be able to presume the matters the user wants to know by referring to the result in the history of searches. At this point, it is desirable that the search result include the title of content extracted by the search, and that the output means outputs information about the content referred to by the user appended to the title of the content. The information about content to which a user has referred is useful in understanding the course of the user's searches. It is also desirable that the search result include the title of contents extracted by the search, and that the output means outputs information on frequency appended to the titles of contents. This will also help the agent in inferring the intent of the user.

The invention provides an apparatus for receiving a request for a search from a user via a network, and performing it based on a search condition entered by the user, characterized in that it comprises a first data base that preserves data being the target of searches to be performed by the user, output means for outputting extracted search results to the user, and receiving means for receiving a predetermined process request from the user for the extracted results, wherein the receiving means performs a search with a second database different from the first database on accepting a predetermined process request, and displays the extracted result of the search performed with the second database along with the search condition.

As has been described, the database for users may not contain answers that match the search condition a user requires. It is the main feature of the information search apparatus according to the invention to make a search with other databases in such a situation. Here, the second database includes not only the previously mentioned in-company database but possibly other ones that are open to the public.

The information search apparatus according to the invention further comprises an agent terminal for responding to a predetermined request to be processed, and it is possible to display the extracted result of the search with the second database and the search condition at the agent terminal.

The present invention has a program that is characterized in having the computer execute the process to recognize the search condition from a user via a network, the process to receive a connection request from the user to an agent, the process to select an agent terminal according to such a connection request, and the process to forward the search condition to the agent terminal. This program makes it possible to realize the above described information search system, the call center system, the server or the information search apparatus by using computers.

### BRIEF DESCRIPTION OF THE DRAWINGS

FIG. 1 illustrates a general configuration of the call center system according to the embodiment;

FIG. 2 is a functional block diagram illustrating the configuration of the call center Web server according to the embodiment;

FIG. 3 is a functional block diagram illustrating the configuration of the agent terminal according to the embodiment;

FIG. 4 is a flowchart showing the operations and process in the information search system;

FIG. 5 is a flowchart showing the operations and process in the information search system;

FIG. 6 is a flowchart showing the operations and process in the information search system;

FIG. 7 is a flowchart showing the operations and process in the information search system;

FIG. 8 illustrates an exemplary user table according to the embodiment;

FIG. 9 illustrates an exemplary display of the search keyword entry screen at the user terminal according to the embodiment;

FIG. 10 illustrates an exemplary display of the search result at the user terminal according to the embodiment;

FIG. 11 illustrates the contents of the search result at the user terminal according to the embodiment;

FIG. 12 illustrates an exemplary display of search result at the agent terminal according to the invention;

FIG. 13 illustrates the display screen at the user terminal in the case where it is possible to determine an agent in the embodiment; and

FIG. 14 illustrates the display screen at the user terminal in the case where a user requests a reply by e-mail in the embodiment.

### PREFERRED EMBODIMENT

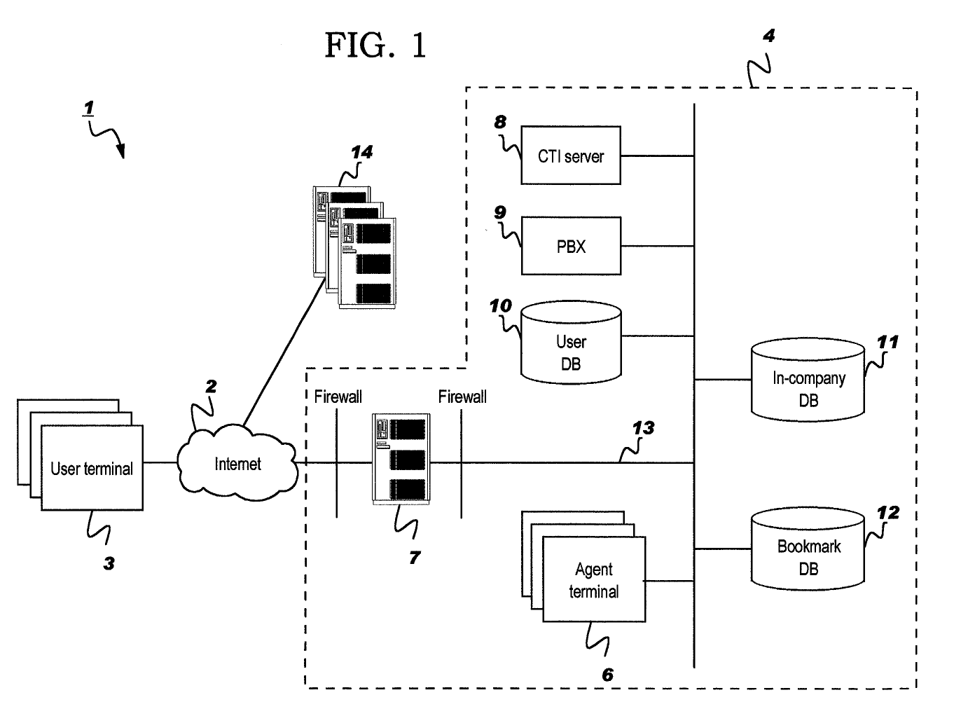

In the following, the call center system according to an embodiment of the invention will be described with reference to FIGS. 1 to 14.

FIG. 1 illustrates a general configuration of the information search system according to the embodiment. The information search system 1 forms a configuration that the user terminal 3 and the call center system 4 are connected via a network such as the Internet 2. The call center system 4 is often called by names such as ‘call center’ or ‘help desk’. This is a system where a user accesses the call center system 4 from the user terminal 3 via the Internet 2, and searches and obtains information that he/she needs.

Each of the user terminals 3 may consist of a personal computer (hereinafter ‘PC’) with a browser installed in it.

Connected through the bus 13 to the server 7 are the agent terminals 6 owned by each agent in the call center, Also connected to bus 13 are CTI (Computer Telephony Integration) server 8, PBX (Private Branch Exchange) 9, the user DB 10, in-company DB 11, and the bookmark DB 12.

General external Web servers 14 different from the call center Web server 7 within the call center system 4 are also connected to Internet 2.

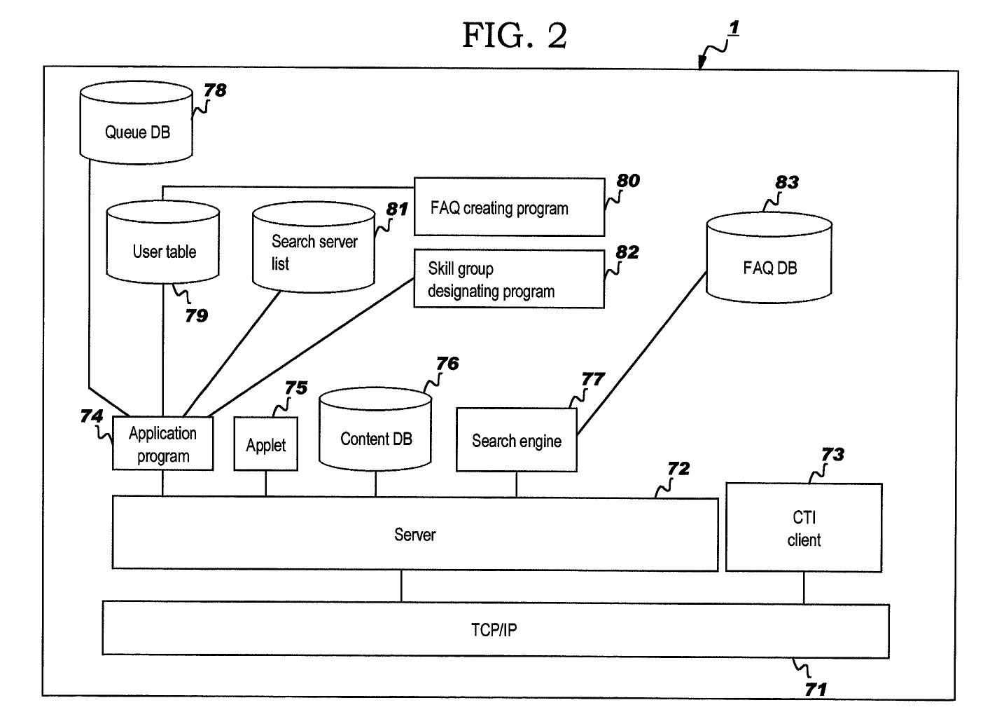

In the call center system 4, the call center Web server 7 owns URL's (Uniform Resource Locators) for accessing FAQ's (Frequently Asked Questions) within the call center system 4. The call center Web server 7 is installed in a region called De-Militarised Zone (DMZ) surrounded by a firewall. More detailed configuration of the call center Web server 7 will be described below based on FIG. 2.

The user DB 10 is a database in which the call center system 4 accumulates user data. The user data, user's name, company, telephone number, and history of past inquiries etc. are preserved, and they can be searched with a user ID or an originating phone number as a key.

The in-company DB 11 is a database in which the most recent information such as FAQ's that are not open outside the call center system 4, i.e., information not yet open to the users, is accumulated. When loading information to the call center Web server 7, it may be more difficult to correct information in the user database than adding new matter to the in-company database. Therefore the most recent information is accumulated in the in-company DB 11 so that the agents can utilize it, although it is not open outside the call center system 4. The latest information accumulated in the in-company DB 11 is made appropriate or correct in its expressions in such things as sentences or the indications of trademarks etc. before being transferred to the call center Web server 7.

The bookmark DB 12 is a database to preserve URL's that are often referred to in the call center system 4.

The call center Web server 7 will now be described referring to the block diagram shown in FIG. 2.

As shown in the drawing, the call center Web server 7 (referred as 1 in FIG. 2) comprises a TCP/IP (Transmission Control Protocol/Internet Protocol) stack 71, which is the standard protocol of the Internet 2. It also comprises a server 72, CTI client 73, application program 74, applet 75, content DB 76, search engine 77, Queue DB 78, user table 79, FAQ creating program 80, search server list 81, skill group designating program 82, and FAQ DB 83.

As shown in FIG. 2, the application program 74 runs on the server 72. The program 74 executes various processes in the call center Web server 1, details of which will be later described. The applet 75 and the content DB 76 are located in a directory managed by a server 72. And the search engine 77 either operates under the control of server 72, or is called by other programs running on the server 72.

The CTI client 73 is a client application corresponding to the CTI server 8. As will be described, the similar CTI client 73 is installed in the agent terminal 6 as well.?

The applet 75 performs processes when a ‘Call Agent’ or ‘answer by e-mail’ is sent from a user terminal 3, or when URL being viewed by the user at the user terminal 3 is sent to the application program 74.

The content DB 76 preserves contents that are described in a format such as HTML (Hypertext Markup Language). The contents include the results of searches performed by users, as will be described.

The search engine 77 performs a search made by a user with reference to the FAQ DB 83 based on the indication from the application program 74. FAQ DB 83 preserves a collection of answers for FAQ's that is open to users. A search result is converted into HTML and stored in the content DB 76 as a file such as /docroot/kokyaku1/temp1.html , for example. The URL corresponding to the file is set in the user table 79, as will be described.

The Queue DB 78 is a database for storing outstanding items that are waiting to be processed among those to be answered for the users by e-mail.

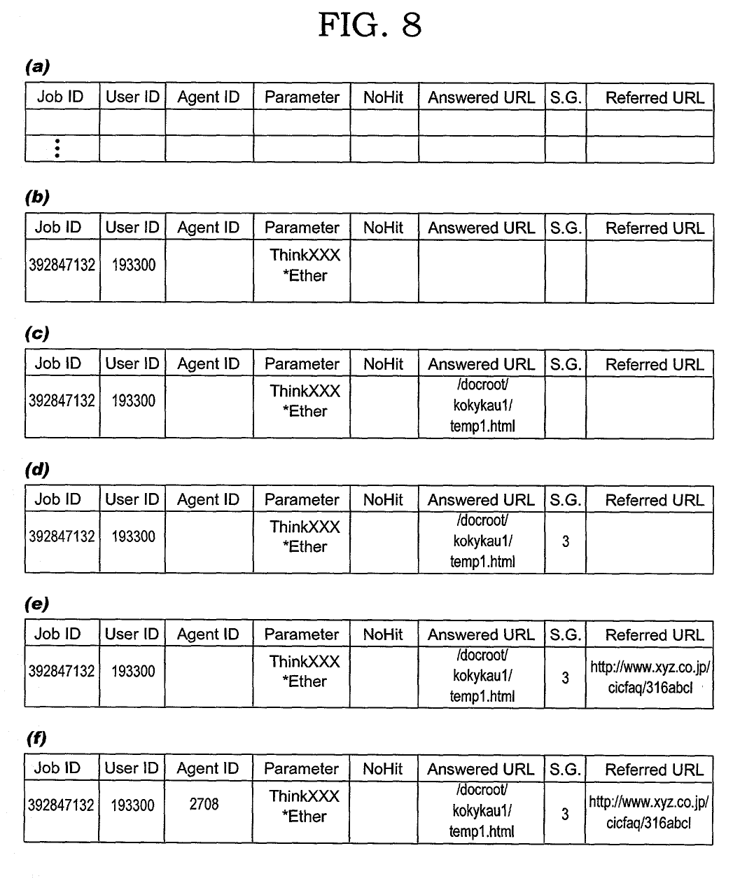

When a user performs a search at the user terminal 3, a number of matters relating to the search are associated with one another and preserved in the user table 79. This includes information such as Job ID, user ID, search expression (parameters) etc., which are the identity information for the search. Examples of the user table 79 are shown in FIG. 8. In FIG. 8, ‘Job ID’, ‘user ID’, ‘Agent ID’, ‘parameters’, ‘No Hit’, ‘answered URL’, ‘S.G. (an abbreviation for ‘skill group ID’), and ‘referred URL’ are associated with each other and preserved. These pieces of information, which are to be maintained as a result of the search by the user, are generally referred to as search history (information). ‘User ID’ and ‘parameters’ are sent from the user terminal 3 when the user performs a search. ‘Job ID’ is unique information generated with the user ID and current time, given at the call center Web server 7 (application program 74, specifically). It is generated so that if the same user makes a plurality of inquiries, each of them can be distinguished.

‘Agent ID’ is identity information on the agent that is selected by the skill group designating program 82 for the inquiry in question.

‘No hit’ is flagged when no answer exists in the FAQ DB 83 for the search performed by the user.

In ‘answered URL’, the URL of a search result obtained with the search engine 77 and FAQ DB 83 is set. For example, previously mentioned /docroot/kokyaku1/temp1.html is set in it.

In ‘S.G.’, the ID of the skill group of the agent selected by the skill group designating program 82 is set. Selection of a skill group and agent is based on a set of parameters.

In the ‘referred URL’, the URL referred to by the user in the search is set.

Returning to FIG. 2, the FAQ creating program 80 is a program that extracts a parameter in a corresponding field and makes the parameter a new FAQ, if ‘No Hit’ in the user table 79 is flagged for a keyword search made by the user.

The search server list 81 associates the in-company DB 11 or an external Web server 14 to be searched with the ID of a skill group and preserves it if there is no hit for a search performed by the user.

The skill group designating program 82 selects a skill group suitable for responding to a search request based on the parameter or parameters set in the user table 79. It also assigns an agent in the appropriate skill group to respond.

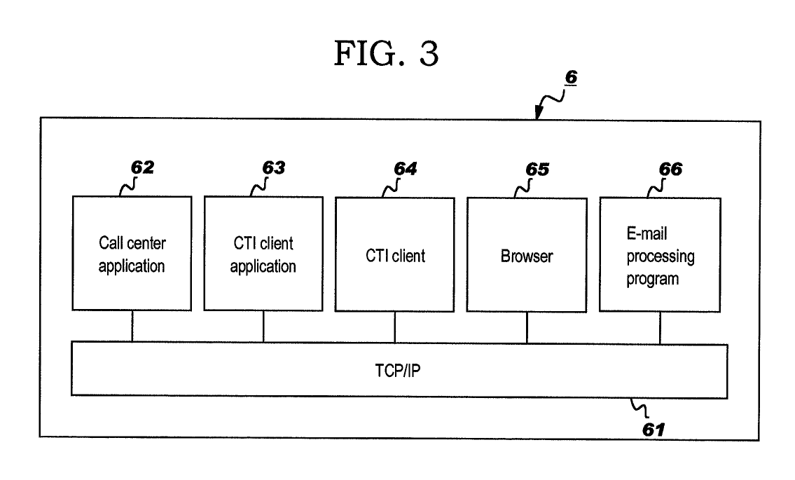

The agent terminal 6 will now be described with reference to the block diagram shown in FIG. 3.

As shown in FIG. 3, an agent terminal comprises a TCP/IP (Transmission Control Protocol/Internet Protocol) stack 61 that is the standard protocol of the Internet 2, call center application 62, CTI client application 63, CTI client 64, browser 65, and e-mail processing program 66.

The call center application 62 records dialogues with a user or displays past histories. The CTI client program 63 is an application created using an API provided by the CTI client 64, and it sets or obtains data from the CTI server 8 in FIG. 1 via the CTI client 64. It sometimes sets data obtained from the CTI server 8 in the call center application 62. Browser 65 is software that is used at an agent terminal 6 to retrieve information. The e-mail processing program 66, together with the browser 65, is responsible for sending/receiving e-mails.

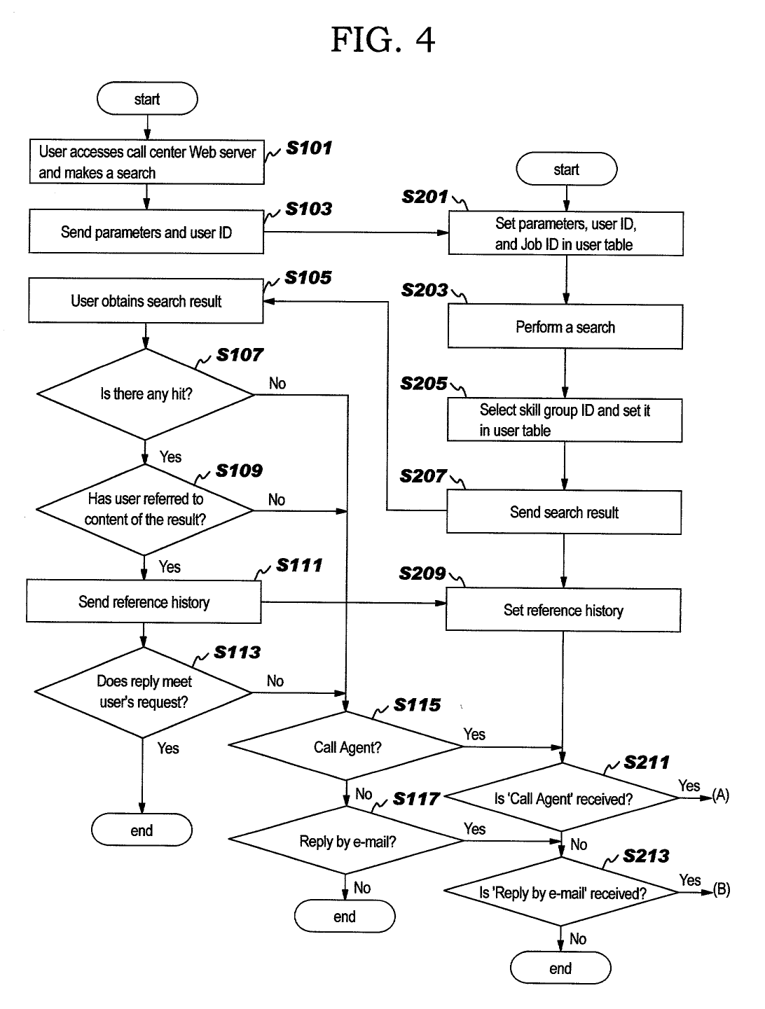

In the following, the operations and procedures in the information search system 1 will be described based on the flowcharts shown in FIGS. 4 to 7.

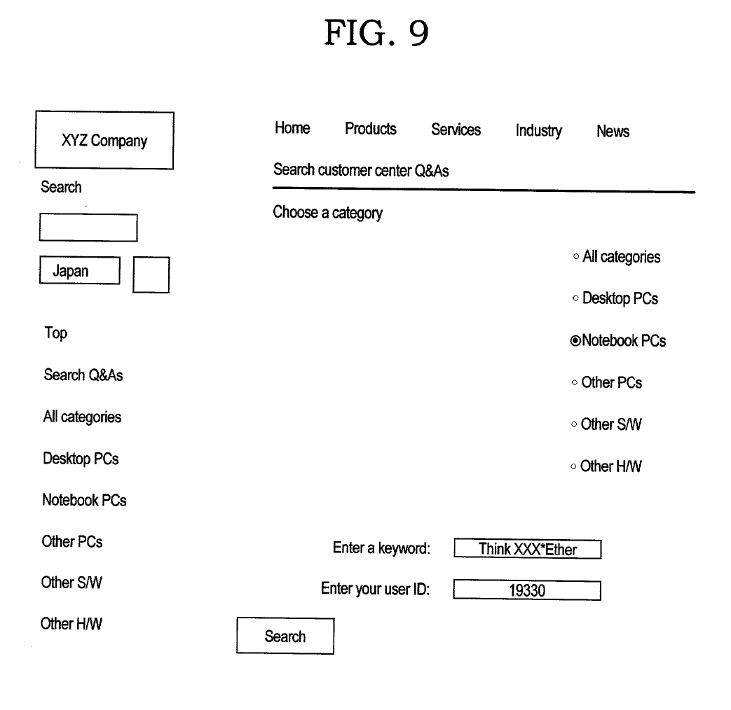

In FIG. 4, the user displays a Web site that is resident at the call center Web server 7 by using the browser of the user terminal 3, and performs a search by entering a search keyword (FIG. 4, S101). In the figure, the left column of steps denotes a procedure of the user, and the right column denotes procedures in the call center system 4. An exemplary screen for keyword entering is shown in FIG. 9. In this example, ‘ThinkXXX* Ether’ is entered as search keywords. A user ID is also required in the screen for entering a search keyword and ‘19330’ is shown entered. However, entry of a user ID may be optional.

After entering the search keywords and the user ID, clicking the ‘Search’ button causes the user terminal 3 to associate the search keywords (hereinafter might be referred to as ‘parameters’) with the user ID and to send them to the call center Web server 7 in the call center system 4 (FIG. 4, S103).

As the call center Web server 7 receives the parameters and user ID, the application program 74 (FIG. 2) creates a Job ID as a unique ID from the user ID and, for example, current time, so that it can be identified even if the same user makes multiple inquiries. Then the parameter, user ID, and Job ID are set in the user table 79 resident in the call center Web server 7 (FIG. 4, S201). The table after setting is shown in FIG. 8b.

Then a search is performed based on the parameters (FIG. 4, S203). The process of performing a search is as follows. The application program 74 sends the parameters to the search engine 77. The search engine 77 refers to the FAQ DB 83 to obtain a search result. The application program 74 converts the search result into HTML and stores it in the content DB 76 as a file such as /docroot/kokyaku1/temp1.html (hereinafter referred to as ‘HTML-1’), for example. This may be stored in a memory. The URL is set in the corresponding field for Job ID in the user table 79. The table after setting is shown in FIG. 8c.

Then the application program 74 obtains the skill group ID of an appropriate agent by the skill group designating program 82 based on the parameters set in the application program 74 (FIG. 4, S205). The logic to select the skill group ID may be defined freely. As an example, if the parameters includes ‘ThinkXXX’, the skill group ‘PC’ may be selected. The obtained skill group ID is set in the user table 79 (FIG. 4, S205). In this example the skill group ID is ‘3’. The table after setting is shown in FIG. 8d.

The application program 74 then sends the search result to the user terminal 3 (FIG. 4, S207). Specifically, it adds the applet 75, which generates for the user a ‘Call Agent’ button and a ‘Reply by e-mail’ button and causes the user's search history and search result to be sent to the call center Web server 7. The applet further adds the Job ID to the HTTP header to return them to the browser of the user terminal 3.

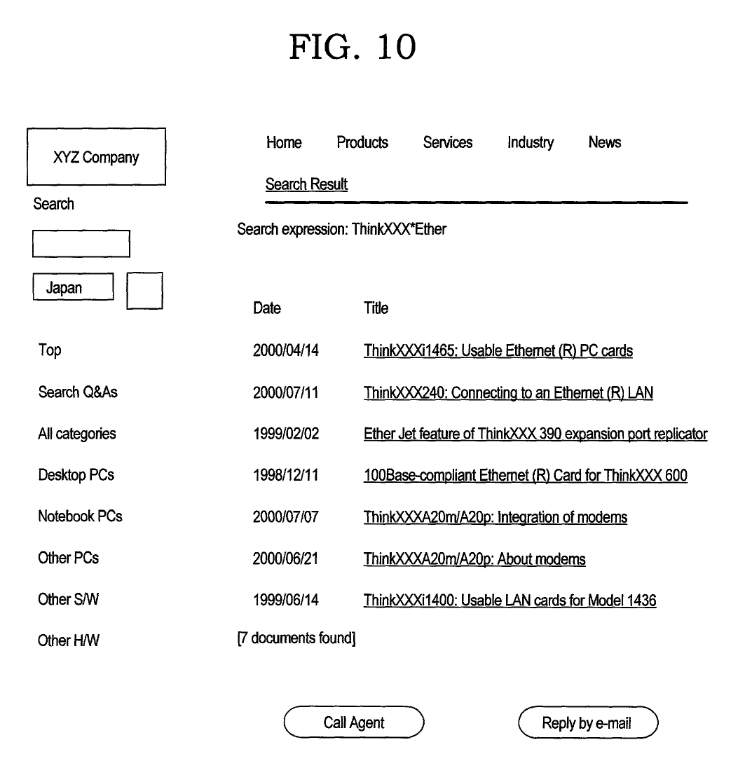

The user obtains the search result at his/her user terminal 3 (FIG. 4, S105). The screen of the user terminal 3 displayed at that time is shown in FIG. 10. In this example, it is displayed that seven answers (hits) have been acquired for the search keyword 'ThinkXXX* Ether’ (FIG. 4, S107). Therefore the user should determine whether any of the seven answers could meet his/her need or not. As shown in FIG. 10, ‘Call Agent’ button and ‘Reply by e-mail’ button are attached to the screen displaying the search result.

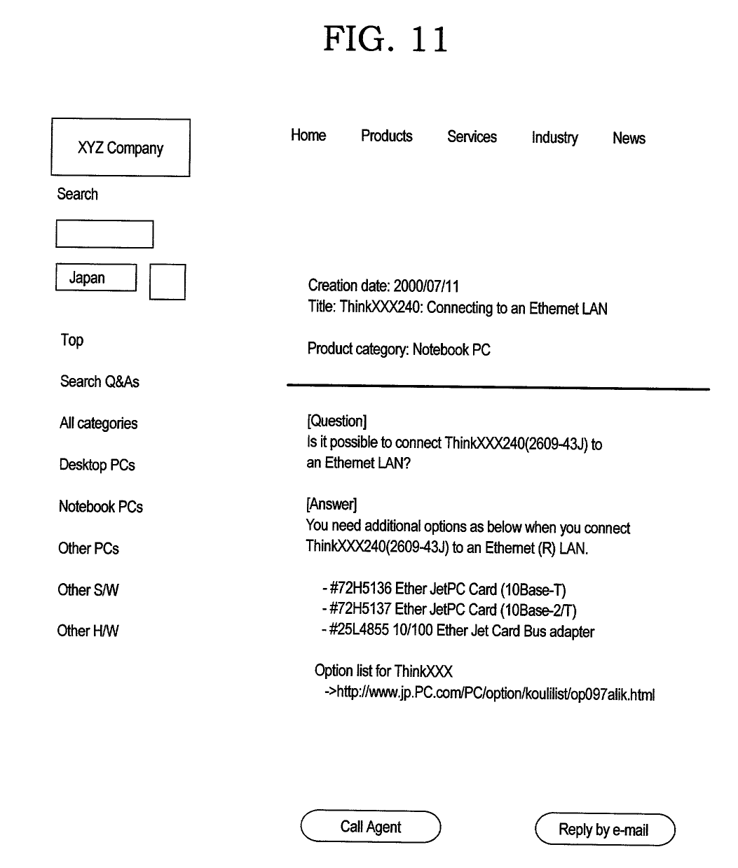

The user determines that ‘ThinkXXX240: Connecting to an Ethernet (R) LAN’ may meet his/her need and refers to the corresponding URL (FIG. 4, S109. The screen of the user terminal 3 displaying the content of the answer for ‘ThinkXXX240: Connecting to an Ethernet (R) LAN’ is shown in FIG. 11). Then the applet 75, which has been sent to the user terminal 3 with the search answer, sends the URL for ‘ThinkXXX 240: Connecting to an Ethernet (R) LAN’ toward the call center Web server 7. Subsequently the applet 75 sends the search history (URL's) made by the user successively to the call center Web server 7 (FIG. 4, S111 ). The search history (URL's) received by the call center Web server 7 is set in the user table 79 by the application program 74 (FIG. 4, S209). The table after setting is shown in FIG. 8e. The screen shown in FIG. 11 also has ‘Call Agent’ button and ‘Reply by e-mail’ button attached. The user will refer to the screen to determine if the result meets his/her need (FIG. 4, S113).

If the user obtains a satisfactory answer, the user closes the Web site being accessed and the process terminates. On the other hand, if there is no answer (there is no hit) for the search (FIG. 4, S107), or if there is no answer to meet his/her need even though there are answers (FIG. 4, S109, S113), the user may request a response by an agent. If the user does not request a response by an agent, the user may close the Web site being accessed and the process terminates.

If the user requests a response by an agent, the user clicks either of the above ‘Call Agent’ or ‘Reply by e-mail’ buttons(FIG. 4, S115, S117). At this point, the ‘Call Agent’ button is selected when the user requires an immediate response by an agent by telephone, and the ‘Reply by e-mail’ button when the user requests getting a later reply by e-mail (FIG. 4, S113, S115). As will be described, the user can obtain a reply from an agent for either of the requests. If the user requests neither of the requests, the user may close the Web site being accessed to terminate the process.

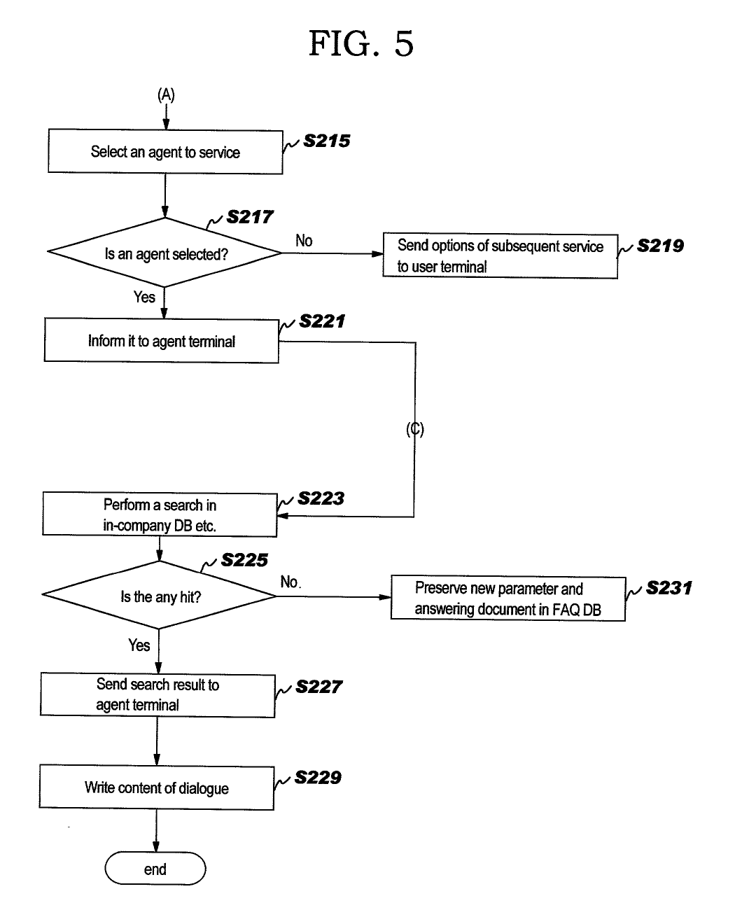

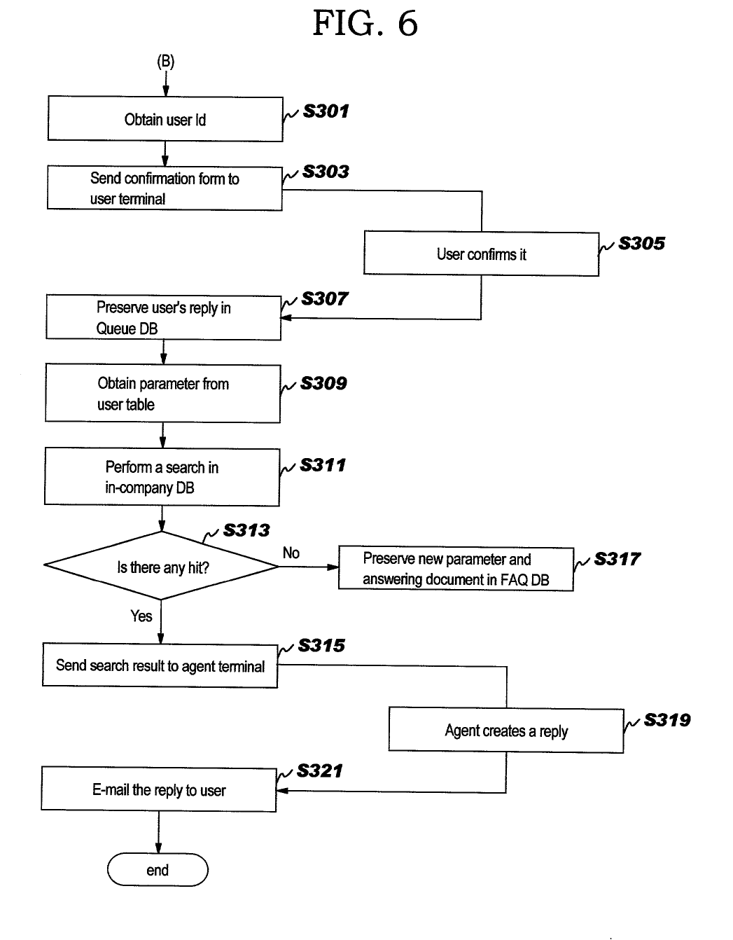

The call center Web server 7 detects the receipt of a ‘Call Agent’ event or a ‘Reply by e-mail’ event from the user terminal 3 at FIG. 4, S211, S213. And if it received a ‘Call Agent’ event, it executes the process denoted as (A) in FIG. 5), and if it received ‘Reply by e-mail’, it executes the process denoted as (B) in FIG. 6. The procedure for the case a ‘Call Agent’ event is received will be first described.

When the call center Web server 7 has received a ‘Call Agent’ event, the application program 74 selects an agent to respond to ‘Call Agent’ as follows (FIG. 5, S215). The application program 74 retrieves the Job ID in the HTTP header and obtains a corresponding skill group ID (3) by searching the user table 79. The application program 74 then sends a request for assigning an agent to the CTI server 8 using the CTI client 73, for the obtained skill group ID. After the CTI server 8 selects an unoccupied agent, the application program 74 receives from the CTI server 8 via the CTI client 73 the event indicating the selection of an agent, the ID of the assigned agent (Agent ID), and a Call ID. The application program 74 sets the agent ID in the user table 79. The table after setting is shown in FIG. 8f. As well, the application program 74 sets the Job ID as Call Data with the Call ID as a key via the CTI client 73 for the CTI server 8.

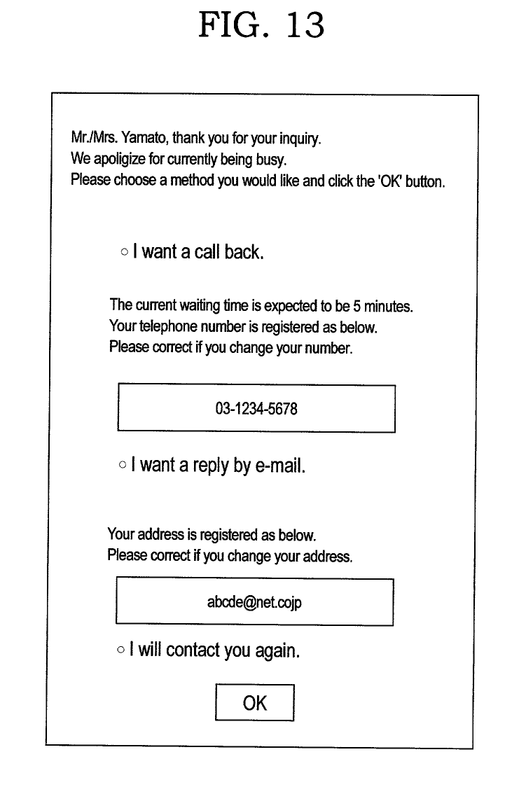

If all of the agents are occupied in servicing and it is impossible to select one, options of subsequent service are sent to the user terminal 3 (FIG. 5, S217, S219). The screen to be displayed at the user terminal 3 is shown in FIG. 13. As shown, the user selects a desired service from the three options; ‘I want a call back’, ‘I want a reply by e-mail’, and ‘I will contact you again’. For ‘I want a call back’ and ‘I want a reply by e-mail’, if the user is registered (such as one that has already acquired his/her user ID), the user's telephone number and e-mail address that are registered in the user DB 10 are indicated in the predetermined fields. If the user is unregistered, it is possible to configure the form to have the user input his/her telephone number, etc. directly. In addition, waiting time may be also indicated for ‘I want a call back.’ The waiting time can be obtained from the PBX 9.

If ‘I want a call back’ is selected, the process starts again with the selection of a servicing agent. If ‘I want a reply by e-mail’ is selected, the process shown in FIG. 6 will be executed.

Meanwhile, notification of the assignment is output to the agent terminal 6 of the assigned agent (FIG. 5, S221). Job ID for which ‘Call Agent’ is requested is passed to the application program 74 through the predetermined process (C), which will be described later.

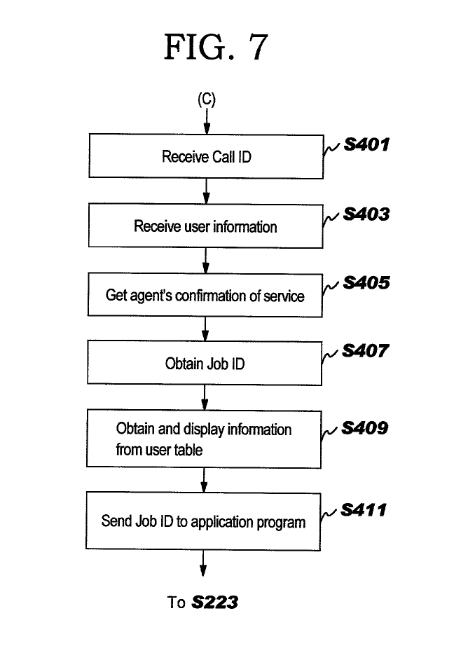

The predetermined process (C) executed at the agent terminal 6 is as illustrated in FIG. 7.

That is, the CTI client program 63, which is monitoring arrivals via the CTI client 73, detects an arrival and gets a Call ID (FIG. 7, S401).

Subsequently, the agent terminal 6 receives and displays the indication to inform the agent of the arrival, and user information (such as user's name and phone number, however only when the user is registered) that may be obtained from the user DB 10 with the user ID as a key (FIG. 7, S403). When the agent confirms to the indication that he/she is going to service, for example by clicking a predetermined button (FIG. 7, S405), the CTI client program 63 obtains the Call Data from the CTI server 8 via the CTI client 73 based on the Call ID obtained in S401, and gets the Job ID that was previously set in the CTI server 8 (FIG. 7, S407).

The CTI client program 63 obtains data in the user table 79 at the call center Web server 7 with the Job ID as a key, and gives the data to the call center application 62. In the call center application 62, the data preserved in the user table 79 is indicated (FIG. 7, S409).

The CTI client program 63 activates the browser 65 and passes the Job ID to the application program 74 on the call center Web server 7 (FIG. 7, S411).

Returning to FIG. 5, the application program 74 performs a search targeted for the in-company DB 11 (and/or the external Web server 14) as follows (FIG. 5, S223). That is, the application program 74 searches the user table 79 with the Job ID as a key to obtain a parameter and a skill group ID. Based on the parameter, it searches the in-company DB 11 using the skill group ID in the user table 79 as a key.

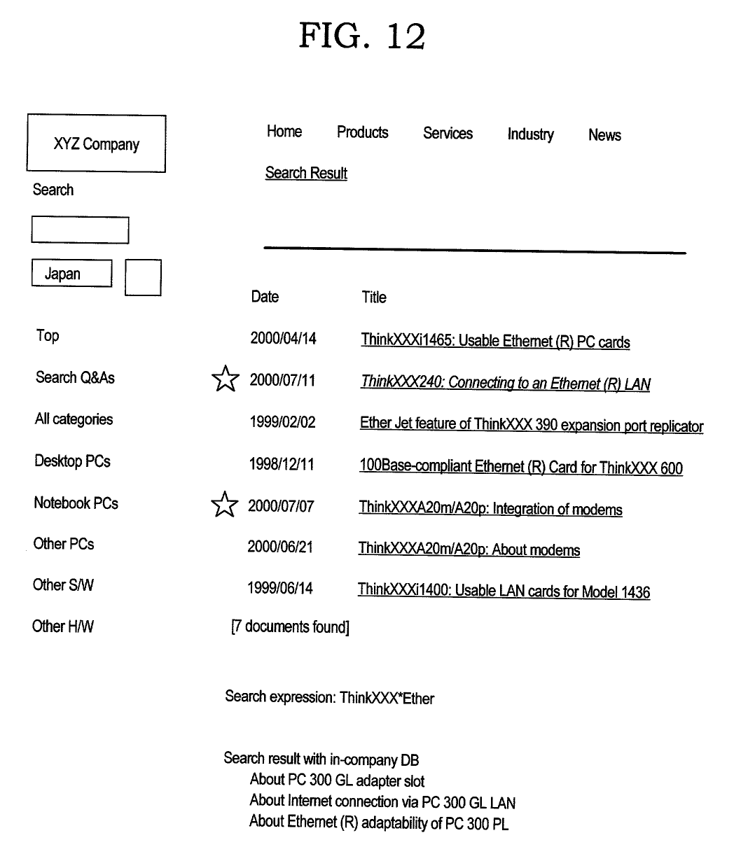

If the search results in any hit, the search result is sent to the agent terminal 6 (FIG. 5, S225, S227). The agent terminal 6 receives and displays the result. The screen displayed at the agent terminal 6 is shown in FIG. 12. This display reflects the result of the search of the in-company DB 11. That is, the result of searching the in-company DB 11 is displayed within the lower area of FIG. 12. The search result is preferably preserved as a memory or a file. Also, which server will be searched in the search is predefined in the search server list 81 for each ID of skill groups. The application program 74 obtains the HTML-1 that has been returned to the user and the search history based on the Job ID, and changes the font of a URL that matches the HTML-1 to return it to the agent terminal 6. FIG. 12 also illustrates this. This is done in order for the agent to be able to recognize that the user has been referred to the URL. Besides changing the font, other methods such as changing colors to emphasize the indication may be adopted as long as it is a recognizable form of representation. Also, URL's that are referred to by users with a high frequency are preserved in the bookmark DB 12 in the call center system 4, so if a match is found in comparison of the bookmarks preserved in the bookmark DB 12 with the URL's in the HTML-1, that URL is indicated in the HTML-1 marked with a star. The HTML-1 thus may also be kept as a modified HTML-2 in the user table 79.

On the other hand, if there is no hit, the ‘No Hit’ field in the user table 79 is flagged. Then, after creating an answering document, the record with the flag in the user table 79 is extracted by the FAQ creating program 80, and its parameter is registered as a new index and associated with the answering document to be preserved in the FAQ DB 83 (FIG. 5, S225, S231).

The selected agent may refer to the search keyword and the URL referred to by the user that are displayed at his/her agent terminal 6. Accordingly the agent can reply promptly without asking the user about the keyword when calling back the user. When the agent finishes the dialogue with the user, the agent writes the content of the dialogue into the user DB 10 through the call center application 62 (FIG. 5, S229), and at the same time the data in the user table 79 obtained in S201 may also be modified and written if required.

In the following, the case where the call center Web server 7 has received a ‘Reply by e-mail’ event (FIG. 4, S213) will be described with reference to FIG. 6.

The application program 74 retrieves the Job ID in HTTP header, searches the user table 79, and obtains the corresponding user ID (FIG. 6, S301).

The application program 74 searches the user DB 10 in the call center based on the obtained user ID, and returns a form describing the user name, e-mail address etc. to the user terminal 3 for the user's confirmation (FIG. 6, S303).

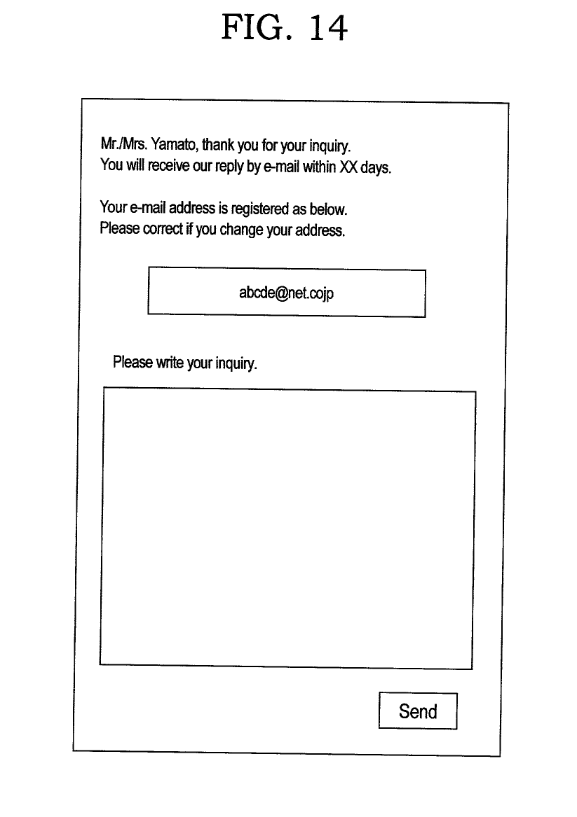

An exemplary form returned to the user terminal 3 is shown in FIG. 14. The form describes the user name (Mr./Ms. Yamato) and his/her e-mail address (abcde@net.co.jp), as well as asks the user to describe his/her inquiry. The requirement for description of the user's inquiry is optional. The user confirms that he/she has requested a reply by e-mail on such a screen and clicks the ‘Send’ button (FIG. 6, S305).

If the user is not registered, data such as the user's e-mail address is not present in the user DB 10. Therefore, necessary data may be obtained directly from the user by displaying a screen to prompt the user to enter such data. Also, the data thus obtained becomes reusable by storing it in the user DB 10.

Subsequently, the application program 74 in the call center Web server 7 receives the reply from the user, and preserves it along with the Job ID in the Queue DB 78 in the call center Web server 7 (FIG. 6, S307).

When an agent replies by e-mail, the agent retrieves the Job ID from the Queue DB 78 through the e-mail processing program 66 on the agent terminal 6, and obtains a parameter from the user table 79 based on the Job ID (FIG. 6, S309).

The application program 74 searches the in-company DB 11 (and/or the external Web server 14) based on the obtained parameter with the skill group ID in the user table 79 as a key (FIG. 6, S311).

If the search results in any hit, the search result is sent to the agent terminal 6 (FIG. 6, S313, S315). The agent terminal 6 receives and displays the result. The display at the agent terminal 6 is similar to that shown in FIG. 12.

On the other hand, if there is no hit, the ‘No Hit’ field of the user table 79 is flagged. Then after creating an answering document, the FAQ creating program 80 extracts a record with the flag in the user table 79, registers the parameter as a new index, and associates the answering document with the parameter to preserve them in the FAQ DB 83 (FIG. 6, S313, S317).

The agent refers to the screen displayed at his/her agent terminal 6 to create an answering document to the user (FIG. 6, S319), and e-mails it to the user (FIG. 6, S321). At this point, a skill group may also be organized for an agent that replies by e-mail, in which case a document that corresponds to the group is automatically selected by the e-mail processing program 66.

A series of operations and procedures thus terminate. As has been described, the information search system 1 according to the embodiment allows an agent to grasp beforehand the search condition entered by a user. Therefore, the user need not to explain his/her search condition to the agent when the agent calls back to the user, and the agent can reply to the user promptly. And when there is a request for a reply by e-mail, the agent may grasp the search condition entered by the user to create an answering document by e-mail. The user may omit the task of entering the search condition again if he/she requests a response by e-mail, which is convenient for a user that is not used to creating documents.

The embodiment described above is merely a desirable form of the invention. Therefore the invention is never to be limited by the described embodiment. Any form appropriately modified may be adopted without departing from the scope of the invention.

What is claimed:

1. An information search system, comprising:
a user terminal connected to a network;
a server for receiving a search condition sent from said user terminal via said network,
and an agent terminal connected to said server;
wherein said server comprises:
a search history preserving unit for preserving the history of a search with said search condition; and
an output unit for outputting said search history preserved in said search history preserving unit to said agent terminal in response to a request from said user terminal for connecting to said agent terminal.

2. The information search system according to claim 1, wherein said search history includes a search keyword input from said user terminal.

3. The information search system according to claim 1, wherein said search history includes information referred to at said user terminal in the course of a search.

4. An information search method, comprising the steps of:
performing a search using a database based on a search condition input from a user terminal via a network;
outputting a search result to said user terminal and preserving a search history;
receiving a request from said user for a response by an agent that is made based on said output search result; and
outputting said search history to an agent that responds to said request for a response by a user.

5. The information search method according to claim 2 or claim 3, wherein said request for a response by an agent comprises a request for a response to said user by telephone.

6. The information search method according to claim 2 or claim 3, wherein said request for a response by an agent comprises a request for a response to said user by e-mail.

7. A call center system, comprising:
an information searching unit for performing a search based on a search condition input by a user via a network;
a preserving unit for preserving said search condition;
a receiving unit for receiving from said user a request for a response by telephone or by e-mail to said search;
an agent selecting unit for selecting an agent to respond to said request for a response by telephone or by e-mail; and
an output unit for outputting to an agent terminal used by said agent said search condition and a search result based on said condition.

8. The call center system according to claim 7, wherein said call center system comprises a first database open to said user and a second database not open to said user, said first database being used to perform a search for said user and said second database being used to perform a search based on said search condition in response to said request for a response.

9. The call center system according to claim 8, wherein said output unit outputs to said agent terminal the result of a search performed using said second database.

10. The call center system according to claim 9, wherein said output unit outputs the result of a search performed using said first database, the result of a search performed using said second database, and said search condition.

11. The call center system according to claim 8, comprising a reply storing unit for associating said search condition with a newly created reply for said search condition and storing said reply in case there is no hit either for the search performed using said first database or for the search performed using said second database.

12. A sever for receiving a request for a search made by a user via a network and outputting the result of the search to said user, comprising:
a search history preserving unit for preserving a history of said search requested by said user, said search being associated with identity information that identifies said search from other searches; and
an output unit for outputting said search history preserved in said search history preserving unit to a terminal used by an agent that responds to a predetermined process request, in response to said predetermined process request to said search result from said user.

13. The server according to claim 12, wherein said output unit outputs said search result to said agent terminal.

14. The server according to claim 13, wherein said search result includes a title of content extracted by the search, and said output unit outputs information about content referred to by said user appended to said title of content.

15. The server according to claim 13, wherein said search result includes a title of content extracted by the search, and said output unit outputs information about frequency with which said content is extracted by searches appended to said title of content.

16. An information search apparatus for receiving a request for a search from a user via a network and performing a search based on a search condition input by the user, comprising:
a first database for preserving data that is subject to a search requested by a user;
an output unit for outputting an extracted result by the search to said user;
and a receiving unit for receiving a predetermined process request to said extracted result from said user;
wherein, on condition that said receiving unit receives said predetermined process request, a search is performed with a second database different from said first database, and the extracted result of said search with said second database is displayed along with said search condition.

17. The information search apparatus according to claim 16, further comprising an agent terminal for responding to said predetermined process request, wherein the extracted result of said search with said second database and said search condition are displayed at said agent terminal.

18. A medium for storing computer program instructions, which when loaded into a computer and executed performs an information search method comprising the steps of:
performing a search using a database based on a search condition input from a user terminal via a network;
outputting a search result to said user terminal and preserving asearchhistory;
receiving a request from said user for a response by an agent that is made based on said output search result; and
outputting said search history to an agent that responds to said request for a response by a user.
